(19) United States
(12) Patent Application Publication
(10) Pub. No.: US 2022/0361680 A1
(43) Pub. Date: Nov. 17, 2022

(54) PLUMBER'S PLATFORM

(71) Applicant: Mark Thomas SCHAEFER, Woodbine, MD (US)

(72) Inventor: Mark Thomas SCHAEFER, Woodbine, MD (US)

(21) Appl. No.: 17/319,713

(22) Filed: May 13, 2021

(51) Int. Cl. A47C 16/00; B25H 3/02

(52) U.S. Cl. CPC A47C 16/005; B25H 3/02

(57) ABSTRACT

The invention of the present disclosure is that of a plumber's platform for supporting the back of a plumber or the like when replacing various plumbing fixtures under a sink, such as a kitchen or bathroom sink. In certain embodiments, a plumber's platform according to the present disclosure may be formed of a hard plastic material such as via thermoplastic molding, and may be configured with fixed or adjustable supports such as legs or feet of various types. In preferred embodiments, a plumber's platform according to the present disclosure may be configured as a lid for a toolbox of appropriate dimensions and may be affixed thereto by various means. A plumber's platform may be unitary, having legs of fixed length, or may comprise extendable or adjustable legs of the same or varying lengths. In preferred embodiments, the platform may comprise one or more tool troughs and a carrying handle cutout.

### STATEMENT REGARDING FEDERALLY SPONSORED RESEARCH OR DEVELOPMENT

The invention described herein was conceived and reduced to practice without the benefit of federal funding.

### BACKGROUND OF THE INVENTION

Plumbers and do-it-yourself homeowners alike are generally familiar with the work required to replace kitchen and bathroom sink faucet assemblies and the like. In most cases, such faucet assemblies are supplied by hot and cold water supply lines that reside in the rear of a lower cabinet underneath of a sink, situated behind a trap connected to a sink drain that prevents odors from escaping from a connected sanitary sewer line into the house via the sink drain.

Typically, a lower cabinet under a sink as described in the previous paragraph will comprise a flat lower interior surface at the bottom of the cabinet that is elevated a few inches above the floor of the room in which the sink is located. The typical sequence of events associated with faucet replacement in these settings is to clear out the cabinet of items stored therein, and then begin the project by lying on one's back on the lower interior cabinet surface with the required tools at one's side (e.g., wrenches, screwdrivers) and loosening the various nuts or other fasteners that hold the faucet and handle assemblies tight to the upper surface of the sink perimeter, which can be a very awkward and uncomfortable process. This process is particularly uncomfortable in part due to the fact that the lower cabinet surfaces are a few inches higher in elevation than the surrounding floor, with the cabinet depth being 2-3 feet from a wall. This leads the person undertaking the faucet replacement to lying with his or her upper back on a horizontal surface that is at a higher elevation than the floor under his or her lower back and legs, creating the need for uncomfortable bending or stiffening of the back.

It is an object of the invention described herein to provide a plumber's platform to improve the comfort level for persons undertaking faucet replacements as described above, including a means for support of the lower back and legs of the person lying under the sink. It is a further object of the invention to include features of a plumber's platform according to certain embodiments disclosed herein to enable the easy storage of tools, thereby avoiding the need to search for tools while in an uncomfortable horizontal position under a sink, or having round-handled tools such as screwdrivers roll off of the sink cabinet onto the floor. It is another object of the invention of the present disclosure to provide a means for easily stowing the platform when not in use, such as foldable or compressible legs or feet, as well as a slot that acts as a handle while also enabling a user to hang the platform, e.g., in a closet or inside of a utility van or truck. It is yet another object to incorporate a plumber's platform as described herein into a toolbox as a toolbox top, reducing the need for extra storage space in addition to that of the toolbox. These and other advantages of the present invention will be evident to one of ordinary skill in the art.

### BRIEF SUMMARY OF THE INVENTION

The invention of the present disclosure is that of a plumber's platform for supporting the back of a plumber, do-it-yourself homeowner, handyman or the like when replacing various plumbing fixtures under a sink, such as a kitchen or bathroom sink. In certain embodiments, a plumber's platform according to the present disclosure may be formed of a hard plastic material such as via thermoplastic molding, and may be configured with fixed or adjustable supports such as legs or feet of various types. In preferred embodiments, a plumber's platform according to the present disclosure may be configured as a lid for a toolbox of appropriate dimensions and may be affixed thereto by various means.

In certain embodiments, a plumber's platform according to the present disclosure may be configured with a trough along each length of the platform for receiving hand tools such as wrenches, screwdrivers and the like. Certain embodiments may also be configured with a carrying handle cutout for carrying the platform as well as hanging on a receiving hook such as on a wall of a shop or inside of a work truck or van. Certain embodiments may also be configured with foldable leg assemblies such that legs at each corner of a substantially rectangular platform may be folded out and locked when in use, then folded in for carrying and storage. Such leg assemblies may comprise four legs of equal length, or may be of varying lengths in order to provide level lower back support on an unlevel floor. Certain embodiments may also be constructed with various structural features such as but not limited to supportive ribs on the underside of the platform.

In certain embodiments, a plumber's platform may alternatively be configured with threaded recesses for receiving complementary threaded leg inserts that may be screwed in and out of the recesses to desired positions, allowing the user to account for uneven floor surfaces while leveling the upper surface of the platform as desired. In still other embodiments, a plumber's platform according the present disclosure may be formed in a single unit with legs of equal length for providing a level surface or varying length, with the legs at one end being of equal length and greater than the length of the legs at the other end, also being equal.

In preferred embodiments, a plumber's platform as described herein may be used as a lid for a toolbox top with corresponding outer dimensions and a means for receiving and securing the plumber's platform to the top of the toolbox. In certain embodiments, a plumber's platform configured as a toolbox lid may be removable vertically from a toolbox beneath and then returned to the toolbox top and secured. In still other embodiments, a plumber's platform may be attached via hinges to the top of a toolbox and configured as a hinged lid of the toolbox.

A plumber's platform as described herein may also be configured with additional features. In certain embodiments, a top surface of a plumber's platform as described herein may include recesses for inserting materials such as pipes and holding them in place while cutting, for example. Other features may include troughs for containing tools, as well as specially fitted adapters for certain types of tools. These and other benefits of the present invention will be evident to those of ordinary skill in the art.

### BRIEF DESCRIPTION OF THE DRAWINGS

FIG. 1 illustrates a top perspective view of an embodiment of a plumber's according to an embodiment of the present invention, with legs extended for use.

FIG. 2 illustrates a bottom perspective view of the embodiment illustrated FIG. 1, with legs extended for use.

FIG. 3 illustrates a top perspective view of the embodiment illustrated FIG. 1, with legs retracted for storage.

FIG. 4 illustrates a bottom perspective view of the embodiment illustrated FIG. 1, with legs retracted for storage.

FIG. 5 illustrates a side view of an embodiment of a plumber's platform according to the present invention with four legs of equal length for providing a level top surface.

FIG. 6 illustrates a side view of an embodiment of a plumber's platform according to the present invention with two legs of equal length positioned at one end of the length of the platform and two legs of equal but greater length at the opposite end of the length of the platform, for providing an inclined surface.

FIG. 7 illustrates a top perspective view of an alternate embodiment of a plumber's platform according to the present disclosure, with threaded legs.

FIG. 8 illustrates a bottom perspective view of an alternate embodiment of a plumber's platform according to the present disclosure, with threaded legs.

FIG. 9 illustrates a side view of the alternate embodiment of a plumber's platform according to FIGS. 7 and 8, with the hidden portion of one of the threaded legs shown in detail.

FIG. 10 illustrates a top perspective view of an alternative embodiment of a plumber's platform according to the present disclosure.

FIG. 11 illustrates a bottom perspective view of the embodiment of a plumber's platform according to the present disclosure as shown in FIG. 10.

FIG. 12 illustrates a top perspective view of a toolbox having a plumber's platform according to an embodiment of the present invention for a lid, with the lid on.

FIG. 13 illustrates a toolbox having a plumber's platform according to an embodiment of the present invention for a lid as shown in FIG. 12, with the lid off.

FIG. 14 illustrates a top perspective view of an alternate embodiment of a toolbox having a plumber's platform for a lid according to an embodiment of the present invention, with the lid on and an intermediate tray fitting inside the toolbox, in the closed position.

FIG. 15 illustrates a toolbox having a plumber's platform for a lid as shown in FIG. 14, in the open position.

FIG. 16 illustrates a front view of an alternate embodiment of a toolbox having a plumber's platform according to an embodiment of the present invention for a lid, the bottom portion of the toolbox equipped with casters, in the open position.

FIG. 17 illustrates a rear view of the alternate embodiment of a toolbox having a plumber's platform according to an embodiment of the present invention for a lid as shown in

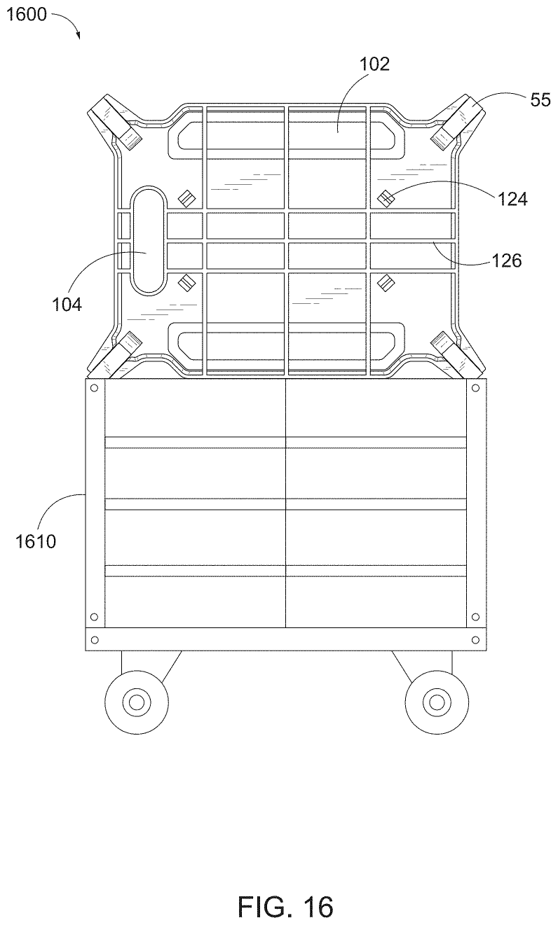

FIG. 16, in the closed position.

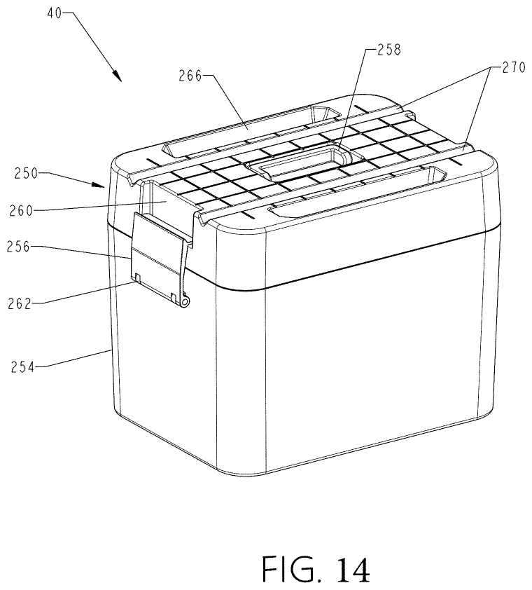

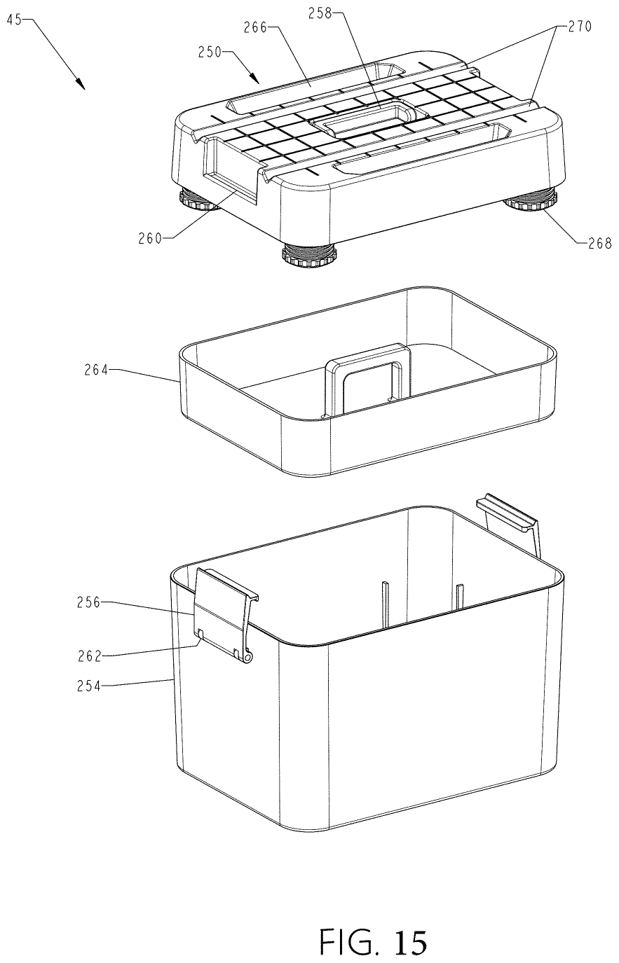

FIG. 18 illustrates a side view of a toolbox as shown in FIGS. 14 and 15, equipped with recesses in the plumber's platform lid for holding pipes in place for cutting.

FIG. 19 illustrates a top perspective view of a toolbox as illustrated in FIG. 18

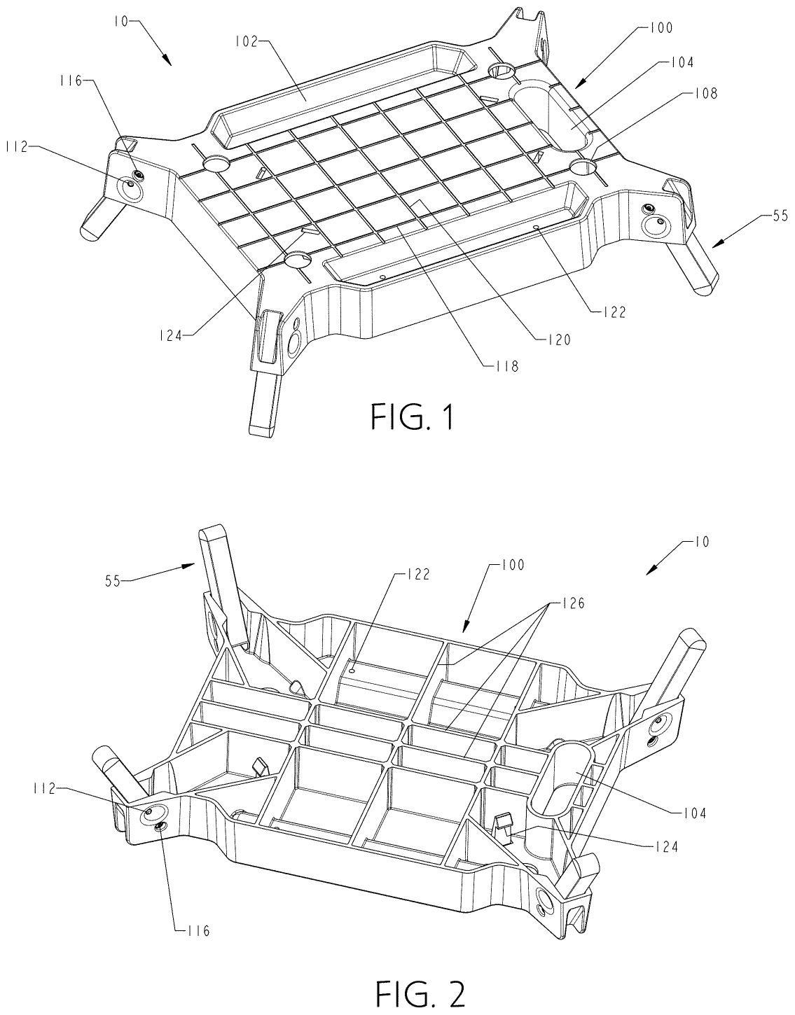

FIG. 20 illustrates an embodiment of a plumber's platform of the present invention as shown in FIGS. 1-4 in use.

### DETAILED DESCRIPTION OF ILLUSTRATIVE EMBODIMENTS

The invention of the present disclosure will be best understood as described with reference to the accompanying drawings. Beginning with FIGS. 1 and 2, an illustrative embodiment of a substantially rectangular plumber's platform according to the present invention is presented in top and bottom perspective views with legs 55 in the extended positions 10 from beneath each corner of the platform. The embodiment of FIGS. 1 and 2 is that of a retractable leg design 100 comprising tool troughs 102 along each side length of the platform. The plumber's platform illustrated in FIG. 1 is further configured with a carrying handle cutout 104 and through holes 108 near each leg assembly to allow a user to access a release mechanism for each of the four legs 55 in order to extend legs 55 when released by pressing a provided tube button 112, which allows each leg 55 to pivot about a leg screw 116 to extend to working position or retract to the stowed position.

In certain embodiments, a plumber's platform as described herein may include visual features such as horizontal grid lines 120 and vertical grid lines 118 on the top surface. In certain embodiments, where tool troughs 102 are provided, each trough may include one or more drain holes 122 in case water falls out of a sink above when the plumber's platform is in use. In certain embodiments, each leg 55 may be spring loaded, such that it must be retained in the stowed position by a provided cantilevered snap feature 124 and when released from the snap feature 124 may simply spring to the extended position. As shown in FIG. 2, a plumber's platform as described herein in retractable leg design 100 may also include structural reinforcements such as ribs 126 to add strength and rigidity to the platform.

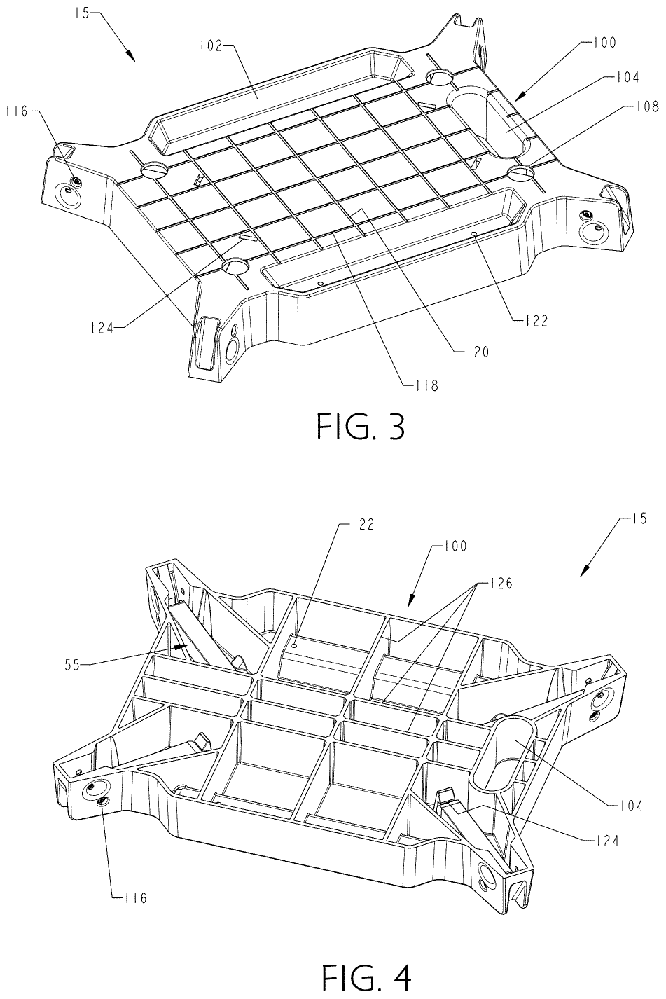

A view of a plumber's platform as shown in FIGS. 1 and 2 with legs 55 in stowed position 15 is shown in FIGS. 3 and 4, including all illustrative features of FIGS. 1 and 2. As suggested above, the legs 55 pivot about a provided leg screw 116, and may be optionally spring loaded. The stowed position 15 allows the user to easily carry the platform by the provided carrying handle cutout 104, which may also be used to hang the platform on a hook such as may be affixed to a wall of a workshop or the interior wall of a van or work truck.

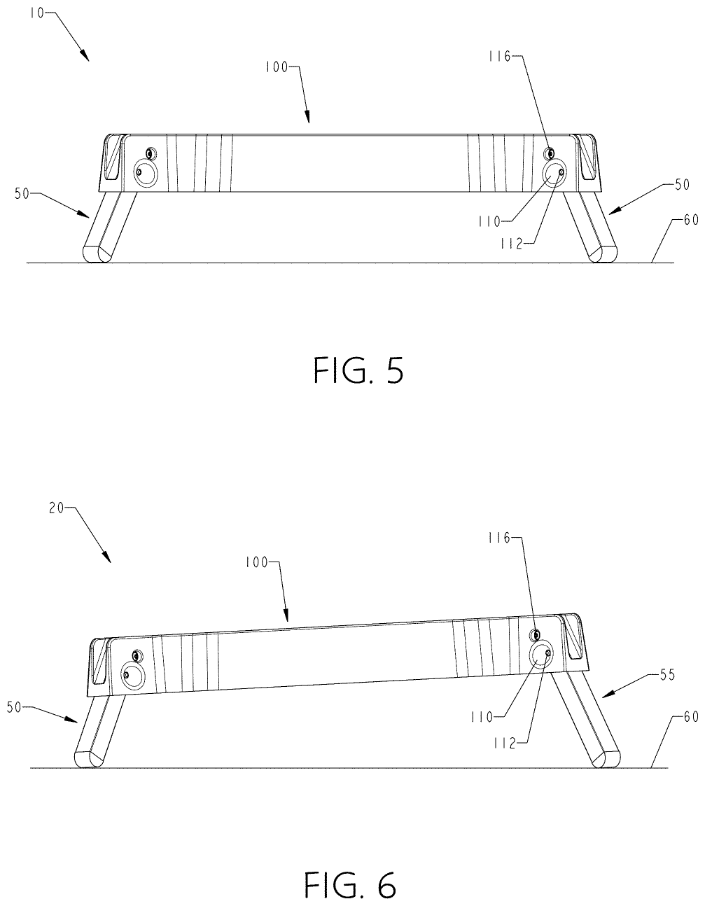

FIG. 5 illustrates a side view with legs 55 in extended position 10 as shown in FIG. 1 in perspective view. This retractable leg design 100 may comprise legs 55 all of equal length, or alternatively may comprise two legs 55 of equal length at one end of the platform, with two legs of lesser and equal length 50 at the opposite end of the length of the platform, thereby providing a user with an inclined top surface to lay on as illustrated in FIG. 6. A slight incline may be advantageous for added comfort for a user while the platform is in use.

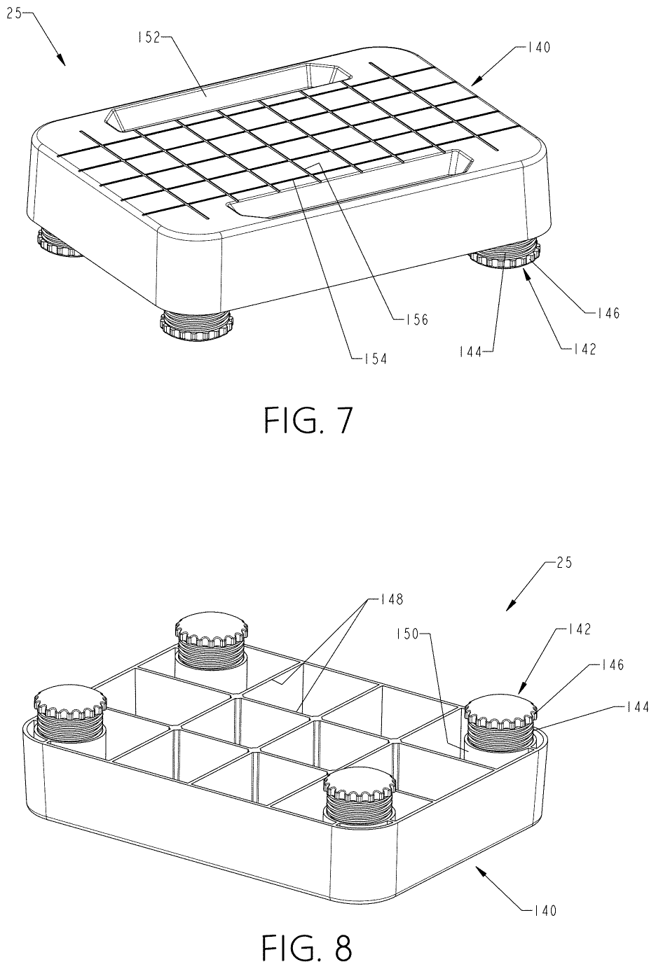

Turning now to FIGS. 7 and 8, an illustrative embodiment of a plumber's platform as described herein is provided, with individually adjustable legs 142 in top perspective 25 and bottom perspective 140 views. Each of the four legs of the platform in this embodiment comprises leg threads 144 and finger grips 146 allowing a user to easily rotate each leg 142 to shorten or lengthen each leg 142. In this way the user can level the top surface of the plumber's platform even in the event that the surface of the floor on which it stands is uneven. Like the embodiment illustrated in FIGS. 1-4, a plumber's platform according to this embodiment may optionally include horizontal lines 156 and vertical lines 154 on the top surface for cosmetic purposes, as well as structural ribs 148 for added strength and rigidity.

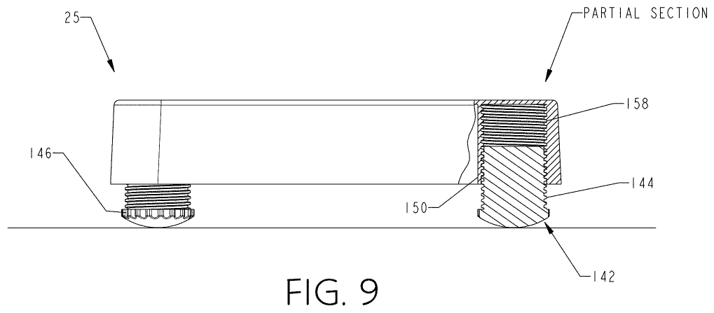

FIG. 9 shows in further detail the operability of a plumber's platform as illustrated in FIGS. 7 and 8. A side view is shown with a partial section of the platform shown transparently to illustrate a screw boss 150 for receiving the leg threads 144 of one of the legs 142, the screw boss 150 comprising internal threads 158 which engage with the leg threads 144 when a user turns the applicable leg using the finger grips 146 in order to achieve a desired leg height for use.

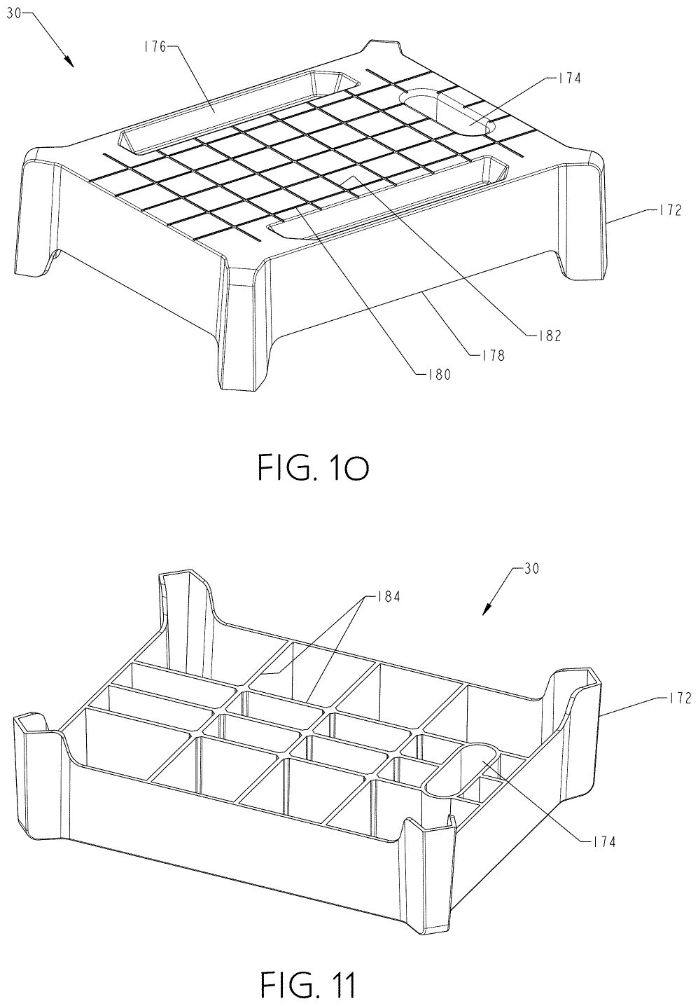

Turning now to FIGS. 10 and 11, an illustrative embodiment of a plumber's platform as described herein is shown as a unitary fixed leg platform 30. Like other configurations, the unitary fixed leg platform 30 may comprise one or more tool troughs 176 and a carrying handle cutout 174 which also may operate as a means for hanging the platform on a wall such as a wall of a workshop or the inner wall of a work truck or van. Each fixed leg 172 is made part of the unitary fixed leg platform 30, such as may be fabricated by extrusion of thermoplastic or similarly suitable material in terms of strength and rigidity. A provided undercut 178 may allow a user to easily pick the platform up from a floor surface after use, and the platform may optionally comprise horizontal lines 182 and vertical lines 180 as cosmetic features of the top surface. Like other embodiments of the invention of the present disclosure, a unitary fixed leg platform 30 may also include structural ribs 184 for added strength and rigidity.

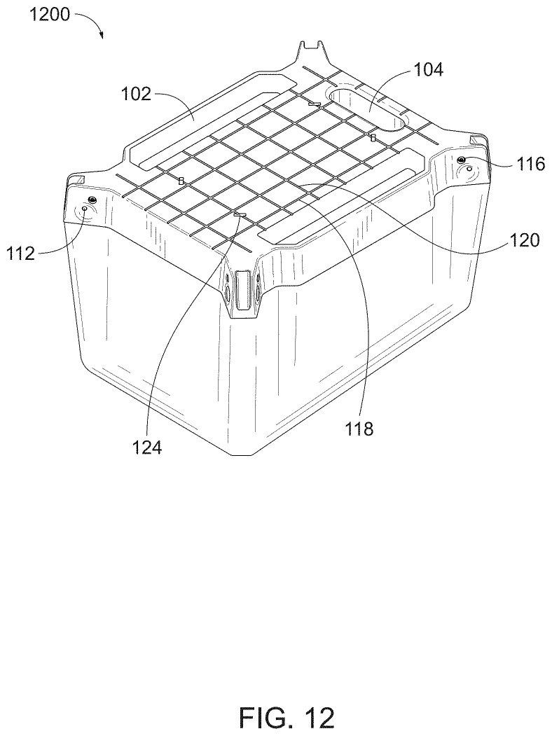

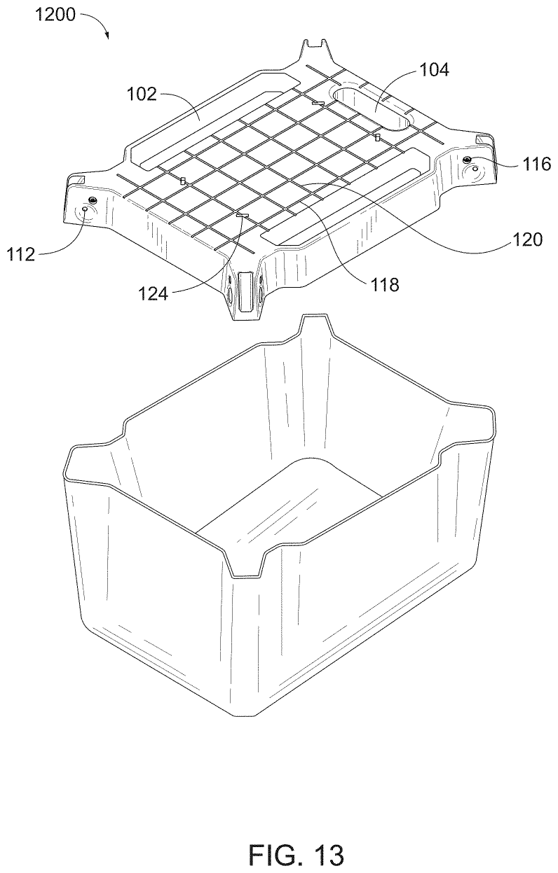

A plumber's platform according to the present invention, including any of its many embodiments, may also be configured as a lid to an appropriately sized toolbox, as first shown in FIG. 12. In FIG. 12, an embodiment of a plumber's platform similar to that first illustrated in FIG. 1 is shown in use as a lid of a toolbox 1200. In this illustrative embodiment, a plumber's platform configured as a toolbox lid comprises one or more tool troughs 102, a carrying handle cutout 104, a tube button 112, a leg screw 116 about which each leg (not shown) may pivot, optional horizontal lines 120 and vertical lines 118 provided for cosmetic purposes, and a cantilevered snap feature 124 useful in spring loaded leg configurations as described above. The plumber's platform illustrated in FIG. 12 as a lid of an accompanying toolbox of suitable size and shape is illustrated again in FIG. 13, lifted above the toolbox below to allow a user to access the contents of the accompanying toolbox.

A plumber's platform according to the present invention, including any of its many embodiments, may also be configured as a lid to an appropriately sized toolbox, as shown again in FIG. 14. In FIG. 14, an embodiment of a plumber's platform similar to that first illustrated in FIG. 7 is shown in use as a lid of a toolbox 250. In this illustrative embodiment, a plumber's platform configured as a toolbox lid 250, illustrated in its integrated form and shown in top perspective view 40, comprises one or more tool troughs 266, four individually adjustable legs 268 (see FIG. 8) configured as previously described with reference to FIGS. 7-9. In addition, pipe grooves 270 are provided such that a user may insert pipes of suitable diameter therein to stabilize them for cutting, such as by a hacksaw or other plumbing implement. A handle 258 is shown for easy lifting off of the plumber's platform from the toolbox, and a recess 260 is provided to accommodate a latch 256 affixed to the toolbox below such that the plumber's platform may be secured to a toolbox base 254 and serve as its lid, the latch comprising a latch pivot 262 about which the latch 256 may rotate to open and close the toolbox.

A plumber's platform as depicted in FIG. 14, integrated as a toolbox lid, is shown again removed from the toolbox base 254 in the open view 45 shown in FIG. 15. In addition to the features illustrated in FIG. 14 and described in the preceding paragraph, a plumber's platform and toolbox combination as described herein may also comprise a tool tray 264 positioned intermediate between the plumber's platform 250 and toolbox base 254, with all other features represented.

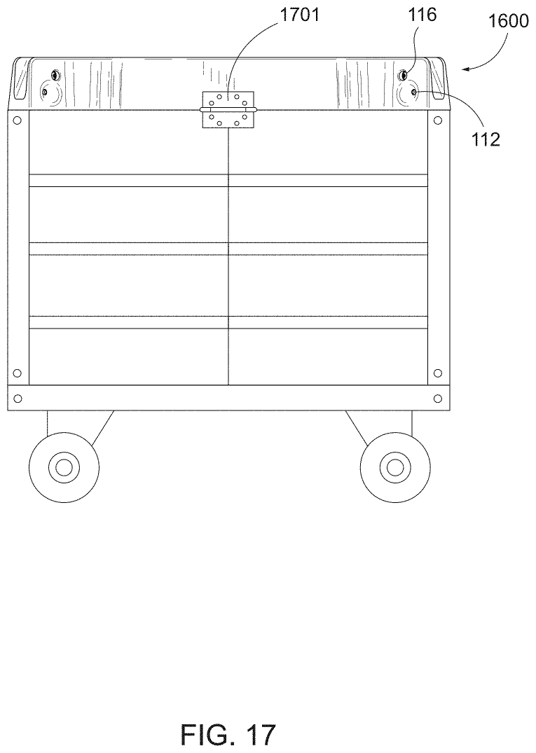

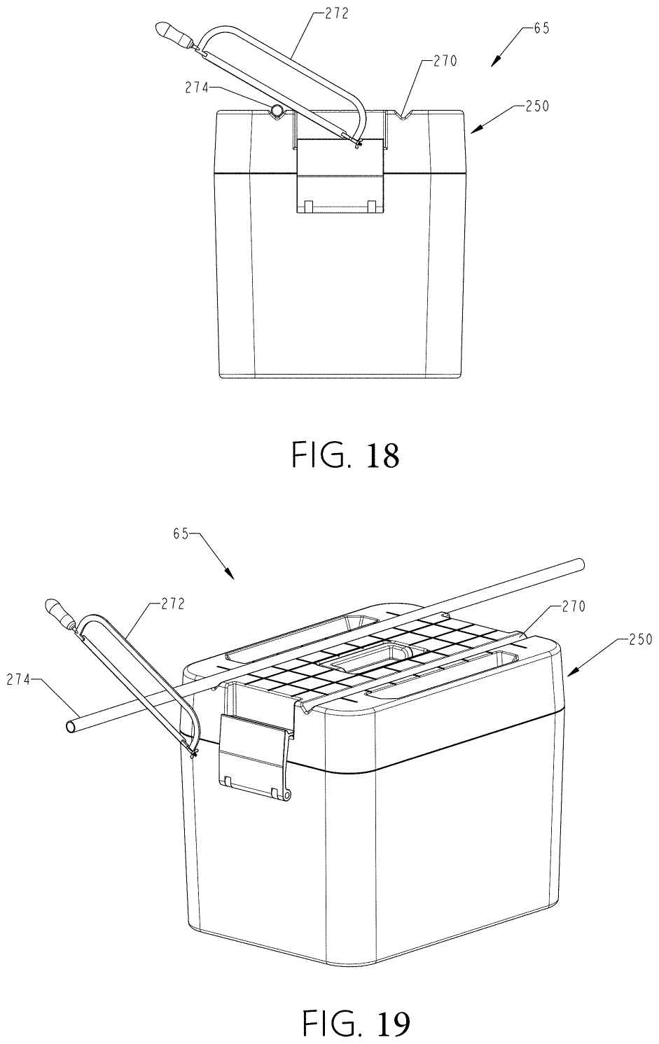

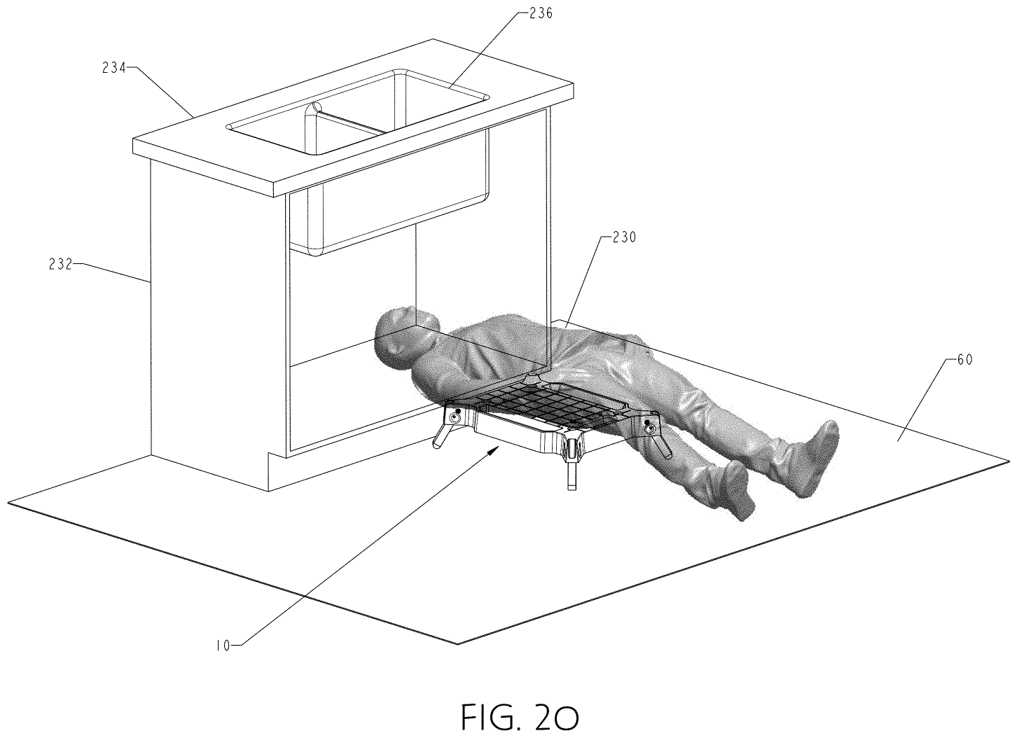

Turning now to FIG. 16, an alternative embodiment 1600 is shown wherein the plumber's platform illustrated is connected to a rolling toolbox base 1610 via hinges. In this embodiment, a plumber's platform with extendable legs similar to that first illustrated in FIG. 1 serves as a lid of a rolling toolbox base 1610, comprising tool troughs 102, extendable legs 55, snap features 124 for spring loaded leg configurations as described previously, structural ribs 126 for reinforcement, a carrying handle cutout 104 for carrying and storing, such as hanging on the wall of a workshop or work truck or van interior wall, and other optional features according to any of the previously described embodiments. As further illustrated in FIG. 17, a removable hinge 1701 is provided, allowing a user to easily remove the plumber's platform from toolbox base 1610 and put it into use. The alternative embodiment of FIG. 16 1600 may also comprise leg screws 116 and tube buttons 112 as shown in FIG. 17.

Turning now to FIGS. 18 and 19, a side view of an embodiment 65 similar to that depicted in FIGS. 14 and 15 is shown with specific attention to the pipe groove 270 utility. For example and not by way of limitation, a hacksaw 272 may be used to cut a pipe secured within a pipe groove 270 of a plumber's platform of the present disclosure. Shown in front view in FIG. 18, a pipe 274 may be inserted into a pipe groove 270 and extended past the front face of the plumber's platform a suitable distance to allow for cutting of the pipe 274 at a desired point along its length. FIG. 19 provides a top perspective view of the front view of the embodiment illustrated in FIG. 18 in side view.

Finally, FIG. 20 is provided to show a plumber's platform similar to that first illustrated in FIG. 1 in use. FIG. 20 shows the platform 10 situated on a floor 60 beneath a user 230 depicted as lying down on the platform 10, thereby leveling the user's back horizontally at substantially the same elevation as the lower interior top surface of cabinet 232 beneath a sink 236 to which fixtures are to be added, recessed within a countertop 234 above the cabinet.

The illustrative embodiments of the invention of the present disclosure described in detail above are provided merely for the purposes of explaining the invention in a manner conducive to understanding by one of ordinary skill in the art, who will appreciate the fact that alternate embodiments beyond those described herein may fall within the scope of the invention and described and claimed herein. These and other embodiments and features equivalent in function to those illustrated herein are considered within scope. The illustrative examples depicted and described herein are designed to meet the statutory requirements of U.S. patent law, but are not meant to be construed as limitation to the scope of the invention.

What is claimed:

1. A platform useful in providing a surface substantially equal in elevation to that of an interior lower cabinet surface beneath a sink or lavatory, the platform comprising a plurality of extendable and retractable legs, the legs being extendable and retractable via rotation about an axis comprising a leg pivot point, said rotation capable of being actuated by the depression of a tube button, wherein the legs may be extended for use or retracted for storage.

2. The platform of claim 1, wherein the legs are spring loaded, further comprising a snap feature capable of engaging with each leg end and securing each leg end beneath the top surface of the platform for storage.

3. A platform useful in providing a surface substantially equal in elevation to that of an interior lower cabinet surface beneath a sink or lavatory, the platform comprising a plurality of extendable and retractable legs, the legs comprising threads and being extendable and retractable via within a screw boss of the platform, said rotation capable of being actuated by the gripping and turning by finger grips, wherein the legs may be extended for use or retracted for storage.

4. The platform of claim 1, further comprising at least one tool trough.

5. The platform of claim 2, further comprising at least one tool trough.

6. The platform of claim 3, further comprising at least one tool trough.

7. The platform of claim 1, further comprising a carrying handle cutout.

8. The platform of claim 2, further comprising a carrying handle cutout.

9. The platform of claim 3, further comprising a carrying handle cutout.

10. The platform of claim 1, further comprising structural ribs beneath the top surface of the platform.

11. The platform of claim 2, further comprising structural ribs beneath the top surface of the platform.

12. The platform of claim 3, further comprising structural ribs beneath the top surface of the platform.

13. The platform of claim 1, wherein the platform is configured to serve as a lid for a toolbox base.

14. The platform of claim 2, wherein the platform is configured to serve as a lid for a toolbox base.

15. The platform of claim 3, wherein the platform is configured to serve as a lid for a toolbox base.

16. The platform of claim 13, wherein the platform is integrated with the toolbox base by at least one hinge.

17. The platform of claim 14, wherein the platform is integrated with the toolbox base by at least one hinge.

18. The platform of claim 15, wherein the platform is integrated with the toolbox base by at least one hinge.

19. The platform of claim 1, further comprising at least one pipe groove.

20. The platform of claim 2, further comprising at least one pipe groove.

21. The platform of claim 3, further comprising at least one pipe groove.

22. The platform of claim 13, further comprising at least one pipe groove.

23. The platform of claim 14, further comprising at least one pipe groove.

24. The platform of claim 15, further comprising at least one pipe groove.
